(19) United States
(12) Patent Application Publication
(10) Pub. No.: US 2025/0229469 A1
(43) Pub. Date: Jul. 17, 2025

(54) INJECTION MOLDING MACHINE

(71) Applicant: THE JAPAN STEEL WORKS, LTD., Tokyo (JP)

(72) Inventor: Kiyotaka NAKAYAMA, Tokyo (JP)

(21) Appl. No.: 19/015,540

(22) Filed: Jan. 9, 2025

(30) Foreign Application Priority Data
Jan. 12, 2024 (JP) 2024-003236

(51) Int. Cl. B29C 45/67; B29C 45/17; B29C 45/28

(52) U.S. Cl. CPC B29C 45/67; B29C 45/281; B29C 2045/1784; B29C 2945/76869

(57) ABSTRACT

An injection molding machine includes a mold clamping device configured to clamp a mold, an injection device configured to inject an injection material, and a plurality of air drive devices including at least two of: an air-driven clamper device mounted on the mold clamping device and configured to clamp and unclamp a mold; an air-driven platen drop preventing device configured to prevent a platen of the mold clamping device from dropping; and an air-driven shut-off nozzle device adapted to be provided in the injection device. At least two air valves configured to supply air to the air drive devices are provided at a same location, which is an air equipment mounting portion.

### CROSS-REFERENCE TO RELATED APPLICATIONS

This application is based on and claims priority under 35 USC 119 from Japanese Patent Application No. 2024-003236 filed on Jan. 12, 2024, the entire content of which is incorporated herein by reference.

### TECHNICAL FIELD

The present disclosure relates to an injection molding machine including an air drive device driven by air, such as a clamp device and a shut-off nozzle device.

### BACKGROUND

An injection molding machine includes, for example, a mold clamping device, an injection device, and the like as described in JP2020-006644A. The injection molding machine often includes a plurality of air drive devices that are driven by air. For example, the air drive device may be a clamp device or a shut-off nozzle device. The clamp device is a device that clamps and unclamps a mold to the mold clamping device. The shut-off nozzle device is a device that closes and opens an injection flow passage in an injection nozzle of the injection device. Each of these air drive devices is provided with an air valve, and the air valves are controlled by a controller.

### SUMMARY

In many air drive devices, a corresponding air valve is provided near the air drive device. By providing the air valve near the air drive device, it is possible to collectively manage a driving target and corresponding air equipment. However, there is also a problem to be solved. The injection molding machine is periodically inspected by a maintenance technician, but this inspection work is becoming more and more complicated, which is an issue. A maintenance technician who specializes in air equipment checks operations of a plurality of air valves, regulators, and the like in sequence. However, since the plurality of air valves are arranged in a distributed manner in the injection molding machine, the maintenance technician needs to inspect the air valves while moving around. That is, the inspection becomes complicated.

The present disclosure provides an injection molding machine that allows efficient inspection by a maintenance technician.

Other problems and novel features will become apparent from description of the present description and the accompanying drawings.

One illustrative aspect of the present disclosure is directed to an injection molding machine including a mold clamping device configured to clamp a mold, an injection device configured to inject an injection material, and a plurality of air drive devices. The air drive devices include at least two of: an air-driven clamper device mounted on the mold clamping device and configured to clamp and unclamp a mold; an air-driven platen drop preventing device configured to prevent a platen of the mold clamping device from dropping; and an air-driven shut-off nozzle device adapted to be provided in the injection device. At least two air valves configured to supply air to the air drive devices are provided at a same location, which is an air equipment mounting portion.

The present disclosure allows for efficient inspection by a maintenance technician on an injection molding machine.

### BRIEF DESCRIPTION OF DRAWINGS

FIG. 1 is a side view of a vertical injection molding machine according to a present illustrative embodiment.

FIG. 2 is a rear view of the vertical injection molding machine according to the present illustrative embodiment.

FIG. 3 is a top view of the vertical injection molding machine according to the present illustrative embodiment.

FIG. 4 is a side view of a vertical injection molding machine according to a comparative example.

FIG. 5 is a rear view of a vertical injection molding machine according to a modification of the present illustrative embodiment.

### DETAILED DESCRIPTION

Hereinafter, specific illustrative embodiments will be described in detail with reference to the drawings. The present disclosure is not limited to the following illustrative embodiments. In order to clarify the description, the following description and the drawings are simplified as appropriate. In the drawings, the same elements are denoted by the same reference numerals, and repeated description thereof is omitted as necessary. In addition, hatching may be omitted to avoid complicating the drawings.

### Present Illustrative Embodiment

### {Injection Molding Machine}

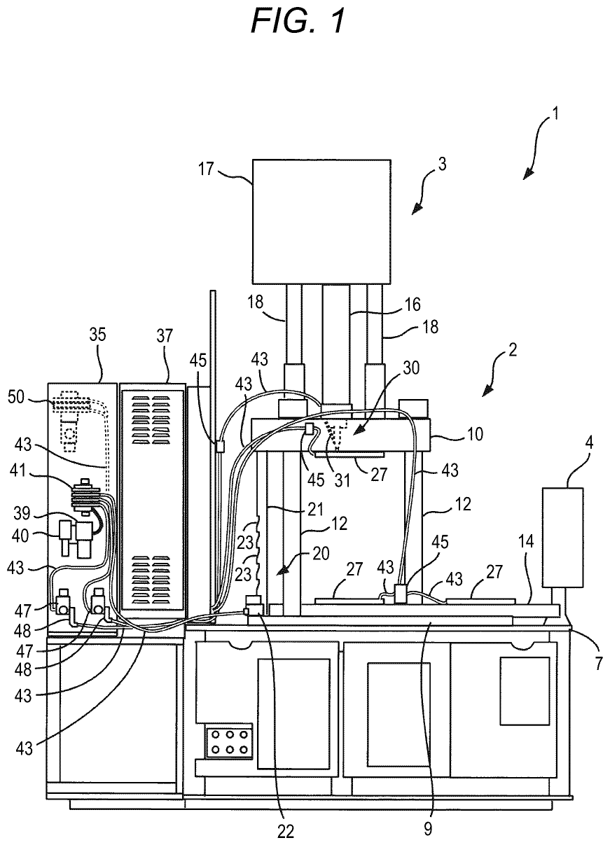

An injection molding machine according to the present illustrative embodiment is a vertical injection molding machine 1. The side view of the machine is shown in FIG. 1. The vertical injection molding machine 1 according to the present illustrative embodiment includes a mold clamping device 2, an injection device 3 provided above the mold clamping device 2, and a controller 4 configured to control the mold clamping device 2 and the injection device 3. As will be described in detail later, the vertical injection molding machine 1 according to the present illustrative embodiment includes a plurality of air drive devices 20, 27, 30 that are driven by air.

### {Mold Clamping Device}

The mold clamping device 2 includes a fixed platen 9 fixed to a bed 7, an upper movable platen 10 provided above the fixed platen 9, and a lower movable platen (not shown) provided in the bed 7. In the present illustrative embodiment, the upper movable platen 10 and the lower movable platen are coupled by three tie bars 12, 12, . . . When a mold clamping mechanism (not shown) provided between the lower movable platen and the fixed platen 9 is driven, the upper movable platen 10 is driven up and down. The mold clamping device 2 has a turntable 14 provided on the fixed platen 9. The turntable 14 is adapted to rotate 180 degrees, or to be reversed, around one of the tie bars 12.

### {Injection Device}

The injection device 3 is provided above the upper movable platen 10 of the mold clamping device 2. The injection device 3 includes a heating cylinder 16, a screw (not shown) provided in the heating cylinder 16, a driving mechanism 17 configured to drive the screw, and lifting-lowering devices 18, 18 configured to lift and lower the entire injection device 3. In the injection device 3, the screw is rotated by the driving mechanism 17 to melt an injection material, and the screw is driven in an axial direction to inject the injection material.

### {Air Drive Device}

The plurality of air drive devices 20, 27, and 30 provided in the vertical injection molding machine 1 according to the present illustrative embodiment will be described. First, the mold clamping device 2 includes a platen drop preventing device 20 as the air drive device 20. The platen drop preventing device 20 includes a safety rod 21 fixed to the upper movable platen 10 and a lock portion 22 provided on the fixed platen 9. The safety rod 21 has a plurality of grooves 23, 23, . . . formed at predetermined intervals. When the lock portion 22 is driven by air, an engaging member provided on the lock portion 22 engages with a predetermined groove 23 to prevent the upper movable platen 10 from dropping. The engaging member is not shown in FIG. 1.

The mold clamping device 2 includes clamper devices 27, 27, . . . as other air drive devices 27, 27, . . . That is, one clamper device 27 and two clamper devices 27 are provided on the upper movable platen 10 and the turntable 14, respectively. When air is supplied to the clamper devices 27, 27, . . . , a mold (not shown) is either clamped or unclamped.

The injection device 3 also includes the air drive device 30. Specifically, it is a shut-off nozzle device 30. The shut-off nozzle device 30 is provided at a tip end of the heating cylinder 16 and includes a needle valve 31. When air is supplied, the needle valve 31 advances to close an injection material flow passage in the shut-off nozzle device 30. Or, the needle valve 31 is retracted to open the injection material flow passage.

### {Air Equipment Mounting Portion}

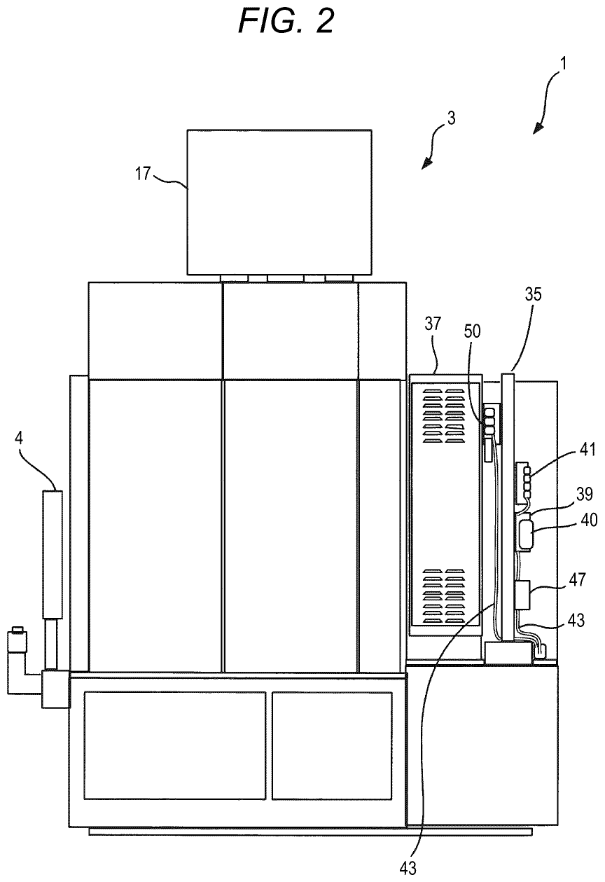

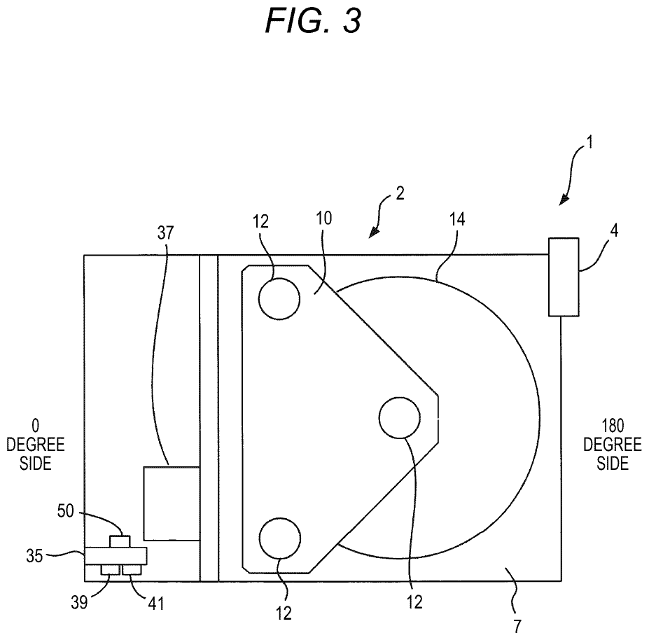

In the vertical injection molding machine 1 according to the present illustrative embodiment, air equipment configured to supply air to the three air drive devices 20, 27, 30 described above, namely, the platen drop preventing device 20, the clamper devices 27, 27, . . . , and the shut-off nozzle device 30, is all collectively mounted on one air equipment mounting portion 35. FIG. 3 shows a top view of the vertical injection molding machine 1 according to the present illustrative embodiment. The controller 4 faces the side from which molded products are removed, and a side that the controller 4 faces and from which the molded products are removed is referred to as a 180-degree side, while its opposite side is referred to as a 0-degree side. In the present illustrative embodiment, the air equipment mounting portion 35 is provided on the 0-degree side of the vertical injection molding machine 1. Specifically, as shown in FIGS. 1 and 2, the vertical injection molding machine 1 includes a housing 37, in which a temperature control panel is housed, on the 0-degree side. The air equipment mounting portion 35, made of a plate-shaped member, is provided in a vertical direction in the vicinity of the housing 37. In order not to impede maintenance of the temperature control panel, the air equipment mounting portion 35 is disposed so as not to interfere with opening and closing of the housing 37. In the vertical injection molding machine 1, the 180-degree side is referred to as the first side, and the 0-degree side as the second side. The side oriented 90 degrees clockwise from the 0-degree side is referred to as the 90-degree side. This 90-degree side, included in the sides oriented between the 0-degree side and the 180-degree side, is also referred to as the third side. The side oriented 90 degrees clockwise from the 180-degree side is referred to as the 270-degree side. This 270- degree side, included in the sides oriented between the 180-degree side and the 0-degree side, is also referred to as the fourth side. The 90-degree side is opposite of the 270-degree side.

A plurality of pieces of air equipment are provided on the air equipment mounting portion 35. First, as shown in FIG. 1, a master valve 39 is provided on one surface (one example of a first surface) of the air equipment mounting portion 35, and although not shown, high-pressure air is supplied from a predetermined air source installed in a factory. The master valve 39 is provided with a residual pressure relief valve 40, which allows air to be safely released when the supply of air from the factory is stopped, thereby preventing malfunction of the air drive devices 20, 27, and 30. One face of the air equipment mounting portion 35 may correspond to the fourth side of the vertical injection molding machine 1.

A multi-air valve unit 41 that groups together a plurality of air valves is provided in the vicinity of the master valve 39. Air supply pipes 43, 43, . . . extend from the respective air valves in the multi-air valve unit 41, and are connected to the corresponding air drive devices 20, 30, that is, the platen drop preventing device 20 and the shut-off nozzle device 30.

Incidentally, for the platen drop preventing device 20, the air supply pipe 43 is directly connected to the air valve in the multi-air valve unit 41. However, for the shut-off nozzle device 30, the air supply pipe 43 is first connected to a relay box 45 provided in the vicinity of the shut-off nozzle device 30, and the air supply pipe 43 is then connected from the relay box 45 to the shut-off nozzle device 30. By providing the relay boxes 45, 45 in this way, even when the shut-off nozzle device 30 is removed, the air equipment and the like can be kept in a mounted state.

The air supply pipes 43, 43 connected to the shut-off nozzle device 30 each are provided with regulators 47, 47 and flow rate adjustment valves 48, 48. The air supplied to the shut-off nozzle device 30 is controlled to a suitable pressure and a suitable flow rate.

As shown in FIG. 2, a clamper air valve 50 is provided on the other surface (one example of a second surface) of the air equipment mounting portion 35. Air supply pipes 43, 43 extend from the clamper air valve 50, and are connected to relay boxes 45, 45 respectively provided on the upper movable platen 10 and the turntable 14 as shown in FIG. 1. Then, the air supply pipes 43, 43 are connected from the relay boxes 45, 45 to the clamper devices 27, 27, . . . In the vertical injection molding machine 1 according to the present illustrative embodiment, many pieces of air equipment are provided in one air equipment mounting portion 35. Therefore, when carrying out maintenance such as inspection of the air equipment, the maintenance can be carried out efficiently. The other face of the air equipment mounting portion 35 may correspond to the third side of the vertical injection molding machine 1.

### Comparative Example

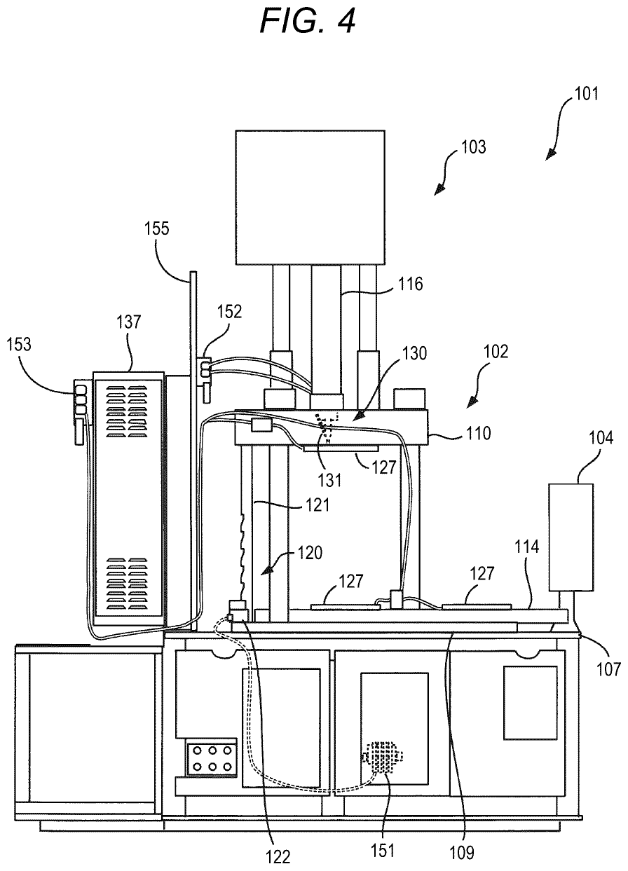

A vertical injection molding machine 101 according to a comparative example will be described with reference to FIG. 4. The vertical injection molding machine 101 according to the comparative example also roughly includes a mold clamping device 102, an injection device 103, a controller 104, and the like. The vertical injection molding machine 101 according to the comparative example also includes a plurality of air drive devices 120, 127, and 130. First, a platen drop preventing device 120 is provided. The platen drop preventing device 120 includes a safety rod 121 provided on an upper movable platen 110 of the mold clamping device 102 and a lock portion 122 provided on a fixed platen 109. The upper movable platen 110 and a turntable 114 are respectively provided with clamper devices 127, 127, . . . Further, a shut-off nozzle device 130, which includes a needle valve 131, is provided in a heating cylinder 116 of the injection device 103.

In the vertical injection molding machine 101 according to the comparative example, air equipment for supplying air to each of the air drive devices 120, 127, and 130 is provided in a distributed manner. First, an air valve 151 for supplying air to the platen drop preventing device 120 is housed in a bed 107. An air valve 152 for supplying air to the shut-off nozzle device 130 is provided in a safety cover 155. An air valve 153 for supplying air to the clamper devices 127, 127, . . . is provided on a back surface of a housing 137 in which a temperature control panel is housed. As described above, in the vertical injection molding machine 101 according to the comparative example, the air equipment is provided in a distributed manner. Therefore, when carrying out maintenance such as inspection on the air equipment, the maintenance technician needs to carry out the inspection while moving around. The maintenance is complicated.

### Modification of Present Illustrative Embodiment

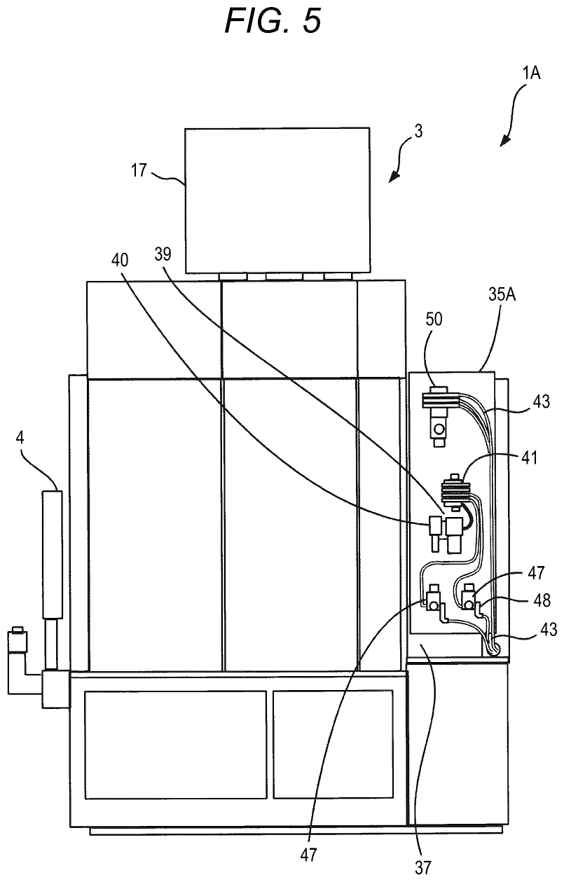

A modification of the present illustrative embodiment will be described with reference to FIG. 5. A vertical injection molding machine 1A according to the modification is configured generally in the same manner as the vertical injection molding machine 1 (see FIGS. 1 and 2) according to the present illustrative embodiment, except that a part of the configuration is different from that of the vertical injection molding machine 1 according to the present illustrative embodiment. Accordingly, members having the same configuration, that is, members having the same function are denoted by the same reference numerals, and description thereof is omitted. In the vertical injection molding machine 1A according to the modification of the present illustrative embodiment, the air equipment mounting portion 35A is modified. Specifically, the back surface of the housing 37 in which the temperature control panel is housed serves as the air equipment mounting portion 35A. That is, various air equipment, that is, the master valve 39, the multi-air valve unit 41, the clamper air valve 50, the regulator 47, and the like are provided on the back surface of the housing 37. In other words, in the vertical injection molding machine 1A according to the modification, the air equipment is collectively provided on the third side. In the vertical injection molding machine 1A according to the modification, the air equipment is collectively provided in one air equipment mounting portion 35A, so that maintenance can be easily carried out.

### Other Modifications

Other modifications are possible for the vertical injection molding machine 1 according to the present illustrative embodiment. For example, in the present illustrative embodiment, it has been described that all pieces of air equipment are provided in the air equipment mounting portion 35 (see FIGS. 1 and 2). However, some of the air equipment may be provided in another place, and it is sufficient if two or more air valves 41, 50 are provided in the air equipment mounting portion 35. This is because it can reduce the burden of maintenance work. Further, in the vertical injection molding machine 1 according to the present illustrative embodiment, it has been described that three air drive devices 20, 27, and 30 are provided. However, it is not necessary to provide all of the air drive devices 20, 27, and 30, but it is sufficient to provide at least two of them. This is because at least two air valves 41, 50 can be provided on the air equipment mounting portion 35. Further, in the present illustrative embodiment, it has been described that the vertical injection molding machine 1 includes a housing 37, in which a temperature control panel is housed, on the 0-degree side (second side). However, instead of or in addition to the housing 37 for the temperature control panel, another housing, such as a power-related housing containing a servo amplifier and a power supply device, may also be provided on the 0-degree side (second side). In this case, the air equipment mounting portion 35 is positioned so as to not interfere with the opening and closing of the housing.

Although the present illustrative embodiment has been described using the vertical injection molding machine 1 according to the present illustrative embodiment, the present disclosure can also be implemented in a horizontal injection molding machine in the same manner. That is, by providing the air equipment mounting portion 35 and collectively arranging the air equipment for the plurality of air drive devices 20, 27, and 30, maintenance can be easily performed in the same manner.

Although the invention made by the present inventor has been specifically described above based on the illustrative embodiments, it is needless to say that the present invention is not limited to the illustrative embodiments described above, and various modifications can be made without departing from the scope of the invention. The plurality of examples described above may be appropriately combined.

What is claimed is:

1. An injection molding machine comprising:
a mold clamping device configured to clamp a mold;
an injection device configured to inject an injection material; and
a plurality of air drive devices,
wherein the air drive devices include at least two of:
an air-driven clamper device mounted on the mold clamping device and configured to clamp and unclamp a mold;
an air-driven platen drop preventing device configured to prevent a platen of the mold clamping device from dropping; and
an air-driven shut-off nozzle device adapted to be provided in the injection device, and
wherein at least two air valves configured to supply air to the air drive devices are provided at a same location, which is an air equipment mounting portion.

2. The injection molding machine according to claim 1, wherein the injection molding machine is a vertical injection molding machine.

3. The injection molding machine according to claim 1, further comprising:
a master valve, the master valve being provided at the air equipment mounting portion such that air supplied from outside is supplied to the air valve via the master valve.

4. The injection molding machine according to claim 1, wherein for the air drive device for which the air valve is provided at the air equipment mounting portion, a regulator, a residual pressure relief valve, and a flow rate adjustment valve are provided at the air equipment mounting portion.

5. The injection molding machine according to claim 2, wherein the vertical injection molding machine includes a controller, and when a side to which the controller faces and from which a molded product is removed is a 180-degree side, and an opposite side is a 0-degree side, the air equipment mounting portion is provided on the 0-degree side.

6. The injection molding machine according to claim 5, wherein the vertical injection molding machine is configured such that a housing, in which a temperature control panel is housed, is disposed on the 0-degree side, a plate-shaped member is provided in a vertical direction in the vicinity of the housing, and the plate-shaped member serves as the air equipment mounting portion.

7. The injection molding machine according to claim 6,
wherein the vertical injection molding machine includes a power supply-related housing, in which a servo amplifier and a power supply device are housed, disposed on the 0-degree side, and
wherein the plate-shaped member is disposed at a position that does not interfere with opening and closing of the power supply-related housing.

8. The injection molding machine according to claim 5,
wherein the vertical injection molding machine is configured such that a housing that accommodates a temperature control panel is disposed on the 0-degree side, and
wherein a back surface of the housing serves as the air equipment mounting portion.

9. The injection molding machine according to claim 1,
wherein the injection molding machine is a vertical injection molding machine, and
wherein the vertical injection molding machine includes a controller that faces a first side from which a molded product is removed, and an opposite side is a second side, and the air equipment mounting portion is provided on the second side.

10. The injection molding machine according to claim 9, wherein the vertical injection molding machine includes:
a housing, in which a temperature control panel is housed, disposed on the second side; and
a plate-shaped member provided in a vertical direction in the vicinity of the housing, the plate-shaped member serving as the air equipment mounting portion.

11. The injection molding machine according to claim 10,
wherein the vertical injection molding machine includes a power supply-related housing, in which a servo amplifier and a power supply device are housed, disposed on the second side, and
wherein the plate-shaped member is disposed at a position that does not interfere with opening and closing of the power supply-related housing.

12. The injection molding machine according to claim 9,
wherein the vertical injection molding machine includes a housing, in which a temperature control panel is housed, disposed on the second side, and
wherein a back surface of the housing that faces a third side serves as the air equipment mounting portion, the third side being oriented between the first side and the second side.
